(19) United States
(12) Patent Application Publication
(10) Pub. No.: US 2016/0146972 A1
(43) Pub. Date: May 26, 2016

(54) Bayesian Updating Method Accounting for Non-Linearity Between Primary and Secondary Data

(71) Applicant: CONOCOPHILLIPS COMPANY, Houston, TX (US)

(72) Inventor: Sahyun HONG, Houston, TX (US)

(21) Appl. No.: 14/950,177

(22) Filed: Nov. 24, 2015

Related U.S. Application Data
(60) Provisional application No. 62/084,224, filed on Nov. 25, 2014.

(51) Int. Cl. G01V 99/00; G06F 17/18

(52) U.S. Cl. CPC G01V 99/005; G06F 17/18

(57) ABSTRACT

Examples of computer-implemented method for geostatistical reservoir modeling include: obtaining a prior probability distribution function using primary data; obtaining a likelihood probability distribution function, via a computer processor, using secondary data, wherein the likelihood probability distribution function is obtained using a Gaussian mixture model that models non-linear relationship between the primary data and secondary data; combining the prior probability distribution function with the likelihood probability distribution function to generate a posterior probability distribution function; and outputting a reservoir model based on the posterior probability distribution function.

### PRIORITY CLAIM

This application is a non-provisional application which claims benefit under 35 USC §119(e) to U.S. Provisional Application Ser. No. 62/084,224 filed Nov. 25, 2014, entitled “BAYESIAN UPDATING METHOD ACCOUNTING FOR NON-LINEARITY BETWEEN PRIMARY AND SECONDARY DATA,” which is incorporated herein in its entirety.

### FIELD OF THE INVENTION

The present invention relates generally to computer-based geostatistical reservoir modeling. More particularly, but not by way of limitation, embodiments of the present invention include tools and methods for integrating probability distribution functions derived from different data sources.

### BACKGROUND OF THE INVENTION

Bayesian updating (BU) technique has been widely adopted by oil and gas industry as an integration method for preparing secondary data for geostatistical reservoir modeling. In general, Bayesian updating uses posterior predictive distribution to predict distribution of a new, unobserved data point. BU estimates unknown quantities by deriving first order moments (mean and variance) of a probability distribution function (pdf) built at unsampled location. A posterior pdf is constructed by combining a prior pdf and a likelihood pdf. The prior pdf can be built by interpolation (e.g., Kriging) using the primary data. A prior built by simple Kriging is a Gaussian pdf. The likelihood is built by a bivariate or multivariate relation between the collocated primary and the secondary data.

Conventional Bayesian updating assumes Gaussian relation (or a linear relation) when modeling the likelihood between the primary and secondary data. Gaussian assumption allows easily modeling the likelihood and to analytically combine a prior and the likelihood leading to a posterior distribution. Conventional Bayesian updating technique is somewhat limited because of its underlying assumption of a multivariate linear (Gaussian) relation between primary and secondary data and thus, likelihood is assumed to be Gaussian. Under Gaussian assumption, the multivariate relation can be fully characterized by correlation coefficients or correlation matrix. However, the non-linear and complex relations between the primary and secondary data often observed in real data (FIG. 1). As shown in FIG. 1, real data often exhibits non-linearity and heteroscedasticity.

### BRIEF SUMMARY OF THE DISCLOSURE

The present invention relates generally to computer-based geostatistical reservoir modeling. More particularly, but not by way of limitation, embodiments of the present invention include tools and methods for integrating probability distribution functions derived from different data sources.

One example of a computer-implemented method for geostatistical reservoir modeling, the method including: obtaining a prior probability distribution function using primary data; obtaining a likelihood probability distribution function, via a computer processor, using secondary data, wherein the likelihood probability distribution function is obtained using a Gaussian mixture model that models non-linear relationship between the primary data and secondary data; combining the prior probability distribution function with the likelihood probability distribution function to generate a posterior probability distribution function; and outputting a reservoir model based on the posterior probability distribution function.

Another example of a computer-implemented method for geostatistical reservoir modeling, the method including: obtaining a prior probability distribution function using primary data that directly measures a physical property of the reservoir; obtaining a likelihood probability distribution function, via a computer processor, using secondary data, wherein the likelihood probability distribution function is obtained using a Gaussian mixture model that models non-linear relationship between the primary data and secondary data; combining the prior probability distribution function with the likelihood probability distribution function to generate a posterior probability distribution function; and outputting a reservoir model based on the posterior probability distribution function.

Yet another example of a computer-implemented method for geostatistical reservoir modeling, the method including: obtaining a prior probability distribution function using primary data that directly measures a physical property of the reservoir; obtaining a likelihood probability distribution function, via a computer processor, using secondary data that indirectly measures a property of the reservoir, wherein the likelihood probability distribution function is obtained using a Gaussian mixture model that models non-linear relationship between the primary data and secondary data; combining the prior probability distribution function with the likelihood probability distribution function to generate a posterior probability distribution function; and outputting a reservoir model based on the posterior probability distribution function.

### BRIEF DESCRIPTION OF THE DRAWINGS

A more complete understanding of the present invention and benefits thereof may be acquired by referring to the following description taken in conjunction with the accompanying drawings in which:

FIG. 1 shows graphs illustrating a non-linear relationship.

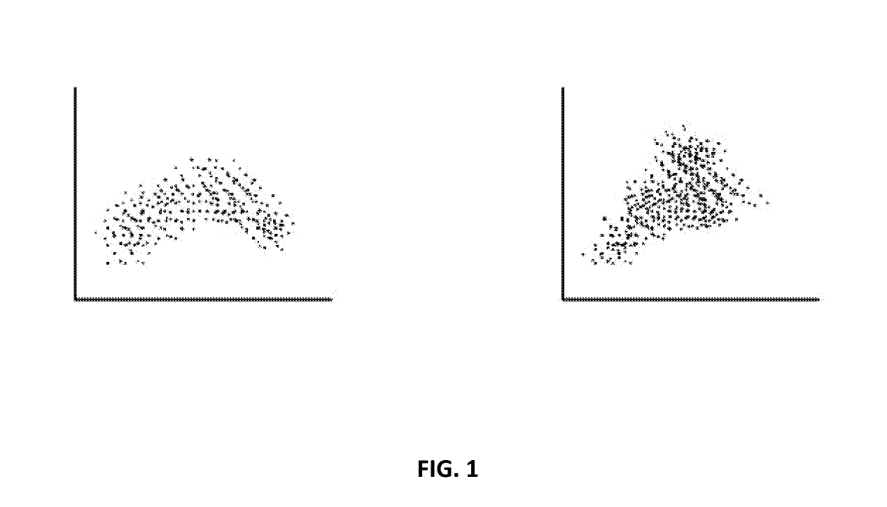

FIG. 2 shows a schematic illustration depicting

FIG. 3 illustrates a Gaussian mixture model for non-parametric data distribution modeling according to an embodiment of the present invention.

FIG. 4 illustrates primary well data according to an embodiment of the present invention.

FIG. 5 illustrates secondary well data according to an embodiment of the present invention.

FIG. 6 shows a cross plot of collocated secondary and primary data.

FIG. 7 shows non-Gaussian likelihood distributions with three different secondary data values.

FIG. 8 shows posterior distributions by combining likelihoods and priors at given secondary data values.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

The present invention provides a non-Gaussian Bayesian updating method using Gaussian mixture model (GMM). More specifically, the present invention provides a non-linear Bayesian updating method that properly accounts for the non-linearity often observed in real data. A framework that can account for non-linear relation between primary and secondary data sets should result in better reservoir modeling.

The present invention can integrate two different probability distribution functions that are derived from different data sources: primary and secondary data. In geostatistical reservoir modeling, well logs are referred to as the primary data because they include direct measurements of reservoir properties in modeling. Seismic, geological and geomechanical property that are exhaustively measured are referred to as the secondary data because they include indirect measurements of the reservoir properties being modeled. Primary data are direct measurements but are limited spatially. By contrast, secondary data are indirect measurements but measured exhaustively over an area.

Bayesian updating technique benefits from two different aspects of data sets. To apply Bayesian updating, spatial interpolation is performed with the primary data. Spatial interpolation predicts primary attribute of interest at unsampled location, and estimates uncertainty (variance) in prediction. Kriging is a common spatial interpolation technique that can generate the prediction as well as variance in the prediction. This is called a prior probability distribution function. Independently, the secondary data can be calibrated with the primary data. The calibration results in the prediction and the variance in the prediction from the relationship between the primary and secondary data. This is called a likelihood probability distribution function.

Over the modeling location, Kriging generates a prior using spatial correlation of the primary data while secondary data generates a likelihood using relationship between collocated primary and secondary data. Bayesian updating combines these two probability functions and generates a posterior probability distribution function that accounts for the primary and secondary data. The combination is done over every modeling location. Conventional Bayesian updating typically assumes a linear or Gaussian relation between the primary and secondary. In general, both probability functions need to be Gaussian in order to be combined.

In the present invention, a new Bayesian updating is developed to account for non-linear relation between the primary and secondary data in order to better reflect real data and improve reservoir modeling results. The Gaussian Mixture Model is used to model the non-linearity in the primary and secondary data relation.

### Derivation of Non-Gaussian Bayesian Updating

Primary and secondary variables are denoted as random variables Z and Y. A posterior distribution of interest is conditional distribution of RV Z at unsampled location u given the surrounding primary and collocated secondary data:

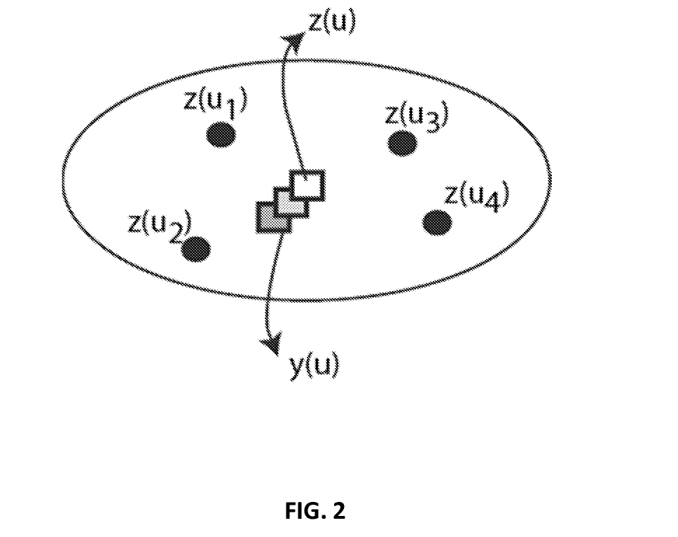

ƒ(z(u)|z(u₁), . . . ,z(uₙ),y(u)), uεA (1)

where z(u₁), . . . , z(uₙ) are surrounding primary data at different locations uᵢ, i=1, . . . , n, and y(u) is a collocated secondary data retained as conditioning data, respectively. This is illustrated by the schematic in FIG. 2.

A single secondary variable y(u) is considered for the simple mathematical notation, but any equations derived in this document can be simply extended into multiple secondary variables using vector Y(u) and matrix notation. Equation (1) can be re-expressed as:

$$\begin{matrix}f ( z ( u ) \vert z ( {u}_{1} ) , … , z ( {u}_{n} ) , y ( u ) ) = \frac{f ( z ( u ) , z ( {u}_{1} ) , … , z ( {u}_{n} ) , y ( u ) )}{f ( z ( {u}_{1} ) , … , z ( {u}_{n} ) , y ( u ) )} \\ = \frac{f ( z ( {u}_{1} ) , … , z ( {u}_{n} ) , y ( u ) \vert z ( u ) ) f ( z ( u ) )}{f ( z ( {u}_{1} ) , … , z ( {u}_{n} ) , y ( u ) )}\end{matrix} \qquad ( 2 )$$

The conditional distribution ƒ(z(u₁), . . . , z(uₙ),y(u)|z(u)) in the numerator can be approximated as ƒ(z(u₁), . . . , z(uₙ),y(u)|z(u))≅ƒ(z(u₁), . . . , z(uₙ)|z(u))×ƒ(y(u)|z(u)) with assumption of independence between collocated y(u) and local surrounding primary data [z(u₁), . . . , z(uₙ)] conditioned to the estimate of primary variable z(u). This assumption of independence alleviates requirement of inferring joint distribution ƒ(z(u₁), . . . , z(uₙ),y(u)|z(u)) that is difficult to model (i.e., requires joint modeling of mixed variables from different locations). Equation (2) is approximated by the conditional independence assumption:

$$f ( z ( u ) \vert z ( {u}_{1} ) , … , z ( {u}_{n} ) , y ( u ) ) = \frac{f ( z ( {u}_{1} ) , … , z ( {u}_{n} ) \vert z ( u ) ) f ( y ( u ) \vert z ( u ) ) f ( z ( u ) )}{f ( z ( {u}_{1} ) , … , z ( {u}_{n} ) , y ( u ) )} \qquad ( 3 )$$

Conditional independence assumption decouples the posterior distribution into two terms: (1) distribution associated with the primary data at different locations, ƒ(z(u₁), . . . , z(uₙ)|z(u)), and (2) distribution associated with the primary and secondary variable relation, ƒ(y(u)|z(u)). Probabilistic terms in right hand side of equation (3) treats unknown estimate z(u) as fixed. By Bayesian relation, they are re-expressed as probability functions of the unknown estimate given fixed data:

$$f ( z ( u ) \vert z ( {u}_{1} ) , … , z ( {u}_{n} ) , y ( u ) ) = \frac{f ( z ( u ) \vert z ( {u}_{1} ) , … , z ( {u}_{n} ) )}{f ( z ( u ) )} \frac{f ( z ( u ) \vert y ( u ) )}{f ( z ( u ) )} f ( z ( u ) ) \cdot C \qquad ( 4 )$$

where normalizing term C is ƒ(z(u₁), . . . , z(uₙ))×ƒ(y(u))/(ƒ(z(u₁), . . . , z(uₙ),y(u)). Because the normalizing term does not affect the unknown z(u), it is summarized as C. Equation Error! Reference source not found. provides a posterior distribution by multiplying three probability distribution functions. ƒ(z(u)|z(u₁), . . . , z(uₙ)) is a conditional distribution of Z conditioned to nearby primary data z(u₁), . . . , z(uₙ). This conditional pdf is called a prior. Kriging that is a spatial interpolation technique parametrically constructs a prior with a mean of Kriging estimate and a variance of kriging variance:

$$f ( z ( u ) \vert z ( {u}_{1} ) , … , z ( {u}_{n} ) ) = \frac{1}{\sqrt{2 π {σ}_{P}^{2} ( u )}} exp \{ - \frac{{( z ( u ) - {z}_{P} ( u ) )}^{2}}{2 {σ}_{P}^{2} ( u )} \} \qquad ( 5 )$$

where z_{P}(u) and σ²_{P}(u) are estimate and estimation variance obtained by simple Kriging at u. Subscript p indicates that z_{P}(u) and σ²_{P}(u) are the statistics derived using the primary data only. ƒ(z(u)|y(u)) in equation Error! Reference source not found. is called the likelihood and can be expressed as:

$$f ( z ( u ) \vert y ( u ) ) = \frac{1}{\sqrt{2 π} {σ}_{S}} exp \{ - \frac{{( z ( u ) - {z}_{S} ( u ) )}^{2}}{2 {σ}_{S}^{2} ( u )} \} \qquad ( 6 )$$

where z_{S}(u) and σ²_{S}(u) are estimate and estimation variance obtained by the relation between the collocated primary and secondary variables. Subscript S of z_{S}(u) and σ²_{S}(u) indicates that they are the statistics derived using the secondary data. Due to the linear relation (Gaussian relation) assumption between Z and Y, conditional mean z_{S}(u) and conditional variance σ²_{S}(u) are simply calculated as z_{S}(u)=ρ×y(u) and σ²_{S}(u)=1−ρ², where ρ is a linear correlation coefficient between Z and Y. z_{S}(u) depends on the given secondary data value at location u but the variance σ²_{S}(u) is constant over uεA and thus σ²_{S}(u)σ²_{S}=1−ρ². Lastly, ƒ(z(u)) in equation Error! Reference source not found. is distribution of the primary variable z(u) over uεA:

$$f ( z ( u ) ) = \frac{1}{\sqrt{2 π {σ}^{2}}} exp \{ - \frac{{( z ( u ) - m )}^{2}}{2 {σ}^{2}} \} \qquad ( 7 )$$

where m and σ² are the mean and variance of the primary variable Z. Elementary probability distribution functions consisting of a posterior distribution in equation (4) are all Gaussian (equations (5), (6) and (7)).

Multiplication of Gaussian distributions is another Gaussian; thus, the posterior distribution becomes Gaussian. Equations shown in (5), (6) and (7) are inserted into equation in (4) as following:

$$\begin{matrix}f ( z ( u ) \vert z ( {u}_{1} ) , … , z ( {u}_{n} ) , y ( u ) ) = \frac{f ( z ( u ) \vert z ( {u}_{1} ) , … , z ( {u}_{n} ) )}{f ( z ( u ) )} \\ \frac{f ( z ( u ) \vert y ( u ) )}{f ( z ( u ) )} f ( z ( u ) ) \cdot C \\ = \frac{\frac{1}{\sqrt{2 {πσ}_{P}^{2} ( u )}} exp \{ - \frac{{( z ( u ) - {z}_{P} ( u ) )}^{2}}{2 {σ}_{P}^{2} ( u )} \}}{\frac{1}{\sqrt{2 {πσ}^{2}}} exp \{ - \frac{{( z ( u ) - m )}^{2}}{2 {σ}^{2}} \}} \\ \frac{1}{\sqrt{2 π {σ}_{S}^{2} ( u )}} exp \{ - \frac{{( z ( u ) - {z}_{S} ( u ) )}^{2}}{2 {σ}_{S}^{2} ( u )} \} \cdot \\ C\end{matrix} \qquad ( 8 )$$

Terms inside exponential function are grouped and terms independent of z(u) are absorbed in the proportionality:

$$f ( z ( u ) \vert z ( {u}_{1} ) , … , z ( {u}_{n} ) , y ( u ) ) ∝ exp \{ - \frac{{( z ( u ) - {z}_{P} ( u ) )}^{2}}{2 {σ}_{P}^{2} ( u )} + \frac{{( z ( u ) - m )}^{2}}{2 {σ}^{2}} - \frac{{( z ( u ) - {z}_{S} ( u ) )}^{2}}{2 {σ}_{S}^{2} ( u )} \} \qquad ( 9 )$$

Equation Error! Reference source not found. is arranged with respect to z(u):

$$f ( z ( u ) \vert z ( {u}_{1} ) , … , z ( {u}_{n} ) , y ( u ) ) ∝ exp \{ - \underbrace{[ \frac{1}{2 {σ}_{P}^{2} ( u )} - \frac{1}{2 {σ}^{2}} + \frac{1}{2 {σ}_{S}^{2} ( u )} ]}_{A} {z}^{2} ( u ) + \underbrace{[ \frac{{z}_{P} ( u )}{{σ}_{P}^{2} ( u )} + \frac{{z}_{S} ( u )}{{σ}_{S}^{2} ( u )} - \frac{m}{{σ}^{2}} ]}_{B} z ( u ) \} \qquad ( 10 )$$

Terms independent of z(u) were absorbed in the proportionality again in equation (10). Equation Error! Reference source not found. follows a quadratic form of exp {−Az²+Bz} where A and B are parameterized coefficients. This can be converted into basic form of Gaussian function:

$$f ( z ( u ) \vert z ( {u}_{1} ) , … , z ( {u}_{n} ) , y ( u ) ) ∝ exp \{ - {Az}^{2} ( u ) + Bz ( u ) \} ∝ exp \{ - \frac{{( z ( u ) - B / 2 A )}^{2}}{2 ( 1 / 2 A )} \} \qquad ( 11 )$$

Posterior distribution ƒ(z(u)|z(u₁), . . . , z(uₙ),y(u)) becomes a Gaussian distribution with mean of B/2A and variance of ½A. The mean and variance of the posterior pdf are denoted as z_{BU}(u) and σ²_{BU}(u) respectively, where BU indicates Bayesian updated statistics:

$${σ}_{BU}^{2} ( u ) = \frac{1}{2 A} \\ and \\ {z}_{BU} ( u ) = \frac{B}{2 A} \qquad ( 12 )$$

Bayesian updated variance and estimate at location u are finally:

$$\frac{1}{{σ}_{BU}^{2} ( u )} = \frac{1}{{σ}_{P}^{2} ( u )} + \frac{1}{{σ}_{S}^{2} ( u )} - \frac{1}{{σ}^{2}} \\ \frac{{z}_{BU} ( u )}{{σ}_{BU}^{2} ( u )} = \frac{{z}_{P} ( u )}{{σ}_{P}^{2} ( u )} + \frac{{z}_{S} ( u )}{{σ}_{S}^{2} ( u )} - \frac{m}{{σ}^{2}} \qquad ( 13 )$$

Equation (13) is final form of the estimate and estimation variance of the primary variable Z accounting for given surrounding primary data and secondary data at unsampled location u. This form is allows calculation of z_{S}(u) and σ²_{S}(u) to be more flexible. For example, various approaches (e.g., Gaussian or non-Gaussian techniques) can be used to obtain z_{S}(u) and σ²_{S}(u).

### Non-Linear Bayesian Updating

Non-linear Bayesian updating is developed based on the derivation shown above. Conventional Bayesian updating assumes a linear relation between Z and Y, and among Y if multiple secondary data (where Y is a vector). Recalling expression of the posterior probability function shown in equation (8):

$$f ( z ( u ) \vert z ( {u}_{1} ) , … , z ( {u}_{n} ) , y ( u ) ) = \frac{f ( z ( u ) \vert z ( {u}_{1} ) , … , z ( {u}_{n} ) )}{f ( z )} f ( z ( u ) \vert y ( u ) ) C \qquad ( 14 )$$

where the posterior probability function is decomposed into three conditional probability distribution functions: a conditional pdf using surrounding primary data [z(u₁), . . . , z(uₙ)], a conditional pdf using secondary data y(u), and a global pdf of the primary variable.

A prior is a Gaussian pdf modeled by simple Kriging. Global pdf is also Gaussian after data transform permitting data to be Gaussian. In the present invention, the likelihood is modeled using a Gaussian mixture model (GMM) to fully account for the complex relation between the primary and secondary data.

GMM can provide flexibility and precision in modeling underlying statistics of simple data compared to traditional unsupervised clustering techniques. In the GMM, several Gaussian probability functions having different means and covariances are weight-summed to characterize non-linearity. The non-linear relation is best characterized by adjusting GMM parameters including number of constituent Gaussian probability functions and means and covariances of Gaussian pdfs and their weights. Expectation-Maximization (EM) algorithm is an optimization algorithm widely used for optimizing these parameters in Gaussian mixture model.

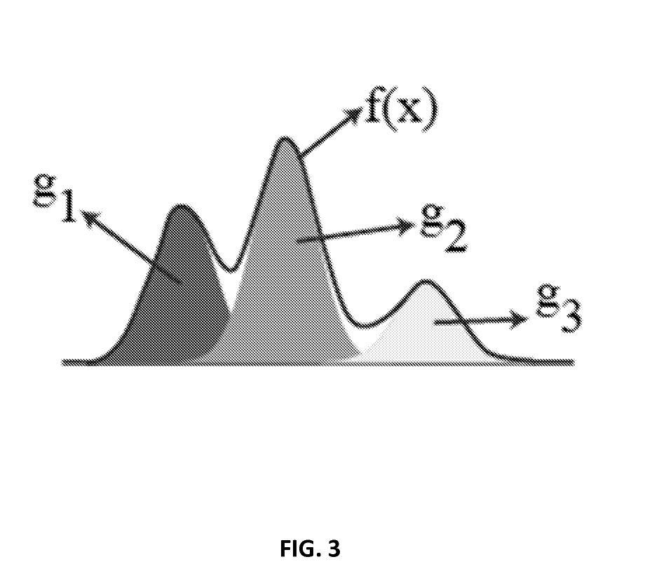

Principle of GMM is to model the data distribution by weighted sum of k Gaussian pdf such as:

$$f ( x ) = {\sum }_{i = 1}^{k} {w}_{i} {g}_{i} \\ and \\ {\sum }_{i = 1}^{k} {w}_{i} = 1 \qquad ( 15 )$$

where ƒ(x) is the modeled pdf, x is the variable of interest, gᵢ, i=1, . . . , k are the Gaussian pdfs with different means and (co)variances, and wᵢ, i=1, . . . , k are the weights assigned to the constituent Gaussian pdf gᵢ, i=1, . . . , k. GMM is convenient in that the probability distribution function can be non-parametrically modeled just by a few parameters. This can be a great benefit when combining a Gaussian prior with the likelihood modeled by GMM. FIG. 3 shows the schematic illustration of the Gaussian mixture model to model non-Gaussian data distribution.

To optimize wᵢ, means and (co)variances of gᵢ and k in equation (15), Expectation-Maximization (EM) algorithm was used. EM algorithm is fairly well-known optimization algorithm for this purpose. The likelihood in equation (14) can be modeled by GMM such as:

ƒ(z(u)|y(u))=w₁g₁(z(u)|y(u))+ . . . +wₖgₖ(z(u)|y(u)) (16)

Once the likelihood is modeled by GMM then the posterior pdf in equation (14) can be written as:

$$f ( z ( u ) \vert z ( {u}_{1} ) , … , z ( {u}_{n} ) , y ( u ) ) = \frac{f ( z ( u ) \vert z ( {u}_{1} ) , … , z ( {u}_{n} ) )}{f ( z )} ( {w}_{1} {g}_{1} ( z ( u ) \vert y ( u ) ) + … + {w}_{k} {g}_{k} ( z ( u ) \vert y ( u ) ) ) C = {w}_{1} ( \frac{f ( z ( u ) \vert z ( {u}_{1} ) , … , z ( {u}_{n} ) )}{f ( z )} {g}_{1} ( z ( u ) \vert y ( u ) ) C ) + … + {w}_{k} ( \frac{f ( z ( u ) \vert z ( {u}_{1} ) , … , z ( {u}_{n} ) )}{f ( z )} {g}_{k} ( z ( u ) \vert y ( u ) ) C ) \qquad ( 17 )$$

Probability functions in each parenthesis are set as hᵢ(z(u)|z(u₁), . . . , z(uₙ),y(u)), i=1, . . . , k and then equation in (17) can be:

ƒ(z(u)|z(u₁), . . . ,z(uₙ),y(u))=w₁h₁(z(u)|z(u₁), . . . ,z(uₙ),y(u))+ . . . +wₖhₖ(z(u)|z(u₁), . . . ,z(uₙ),y(u)) (18)

hᵢ, i=1, . . . , k are also Gaussian because pdfs consisting of hᵢ are Gaussian. Equation (18) states that the posterior probability function can be modeled by weighted sum of hᵢ, i=1, . . . , k where hᵢ are Gaussian. Non-parametric (non-Gaussian) relation in the posterior pdf is characterized by a few parameters such as w k and different means and (co)variances of each hᵢ. This is a significant advantage of GMM over other non-Gaussian distribution modeling techniques. For example, a kernel density estimator is the widely used technique for modeling the non-parametric likelihood, however, the likelihood built by the kernel method cannot be analytically combined with a Gaussian prior. The posterior pdf, thus, cannot have a closed form unless every elementary pdfs are Gaussian.

### Example

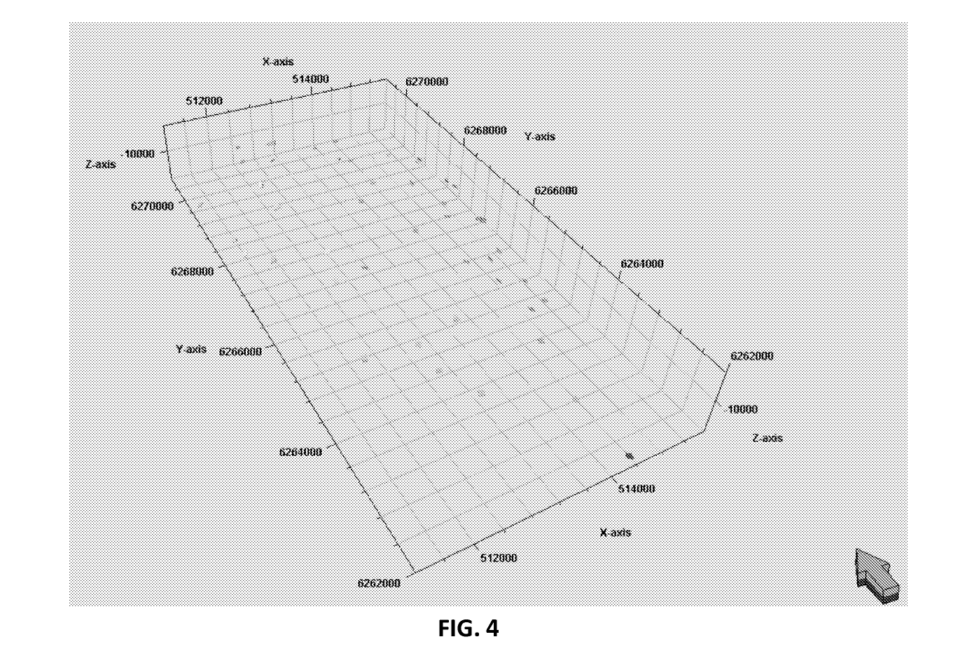

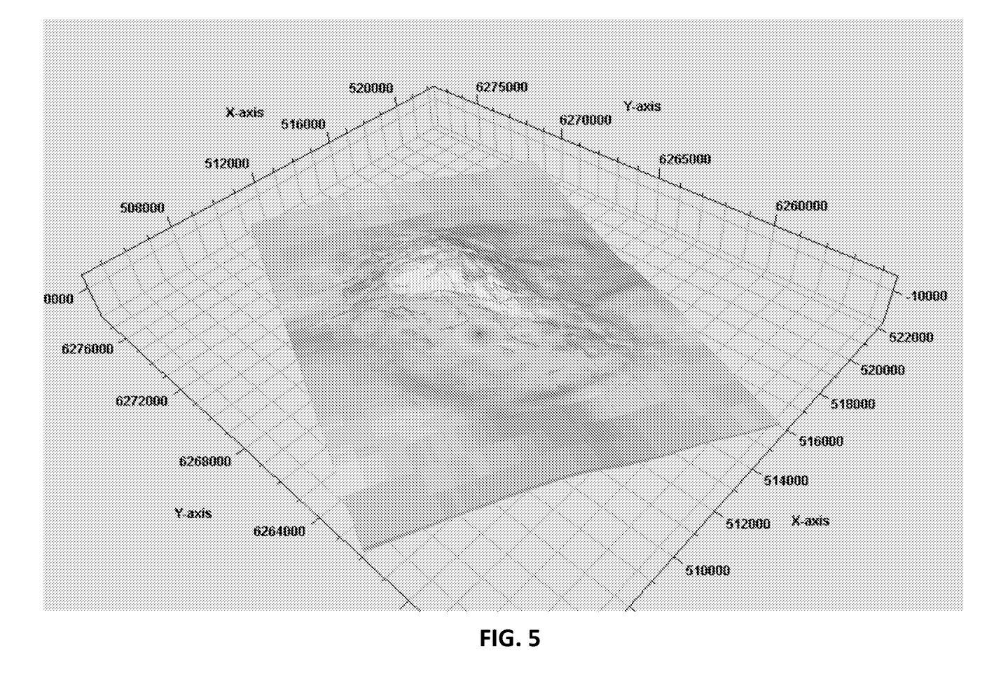

FIGS. 4 and 5 show 3D images of the primary well data and the secondary data in Petrel® (commercially available from Schlumberger, Houston, Tex.) software. The primary data can be a porosity, permeability, bitumen, organic carbon content, and rock type populating in grids. The secondary data can be seismic, geologic map, reservoir property previously modeled, and geomechanical properties that support modeling of the primary data.

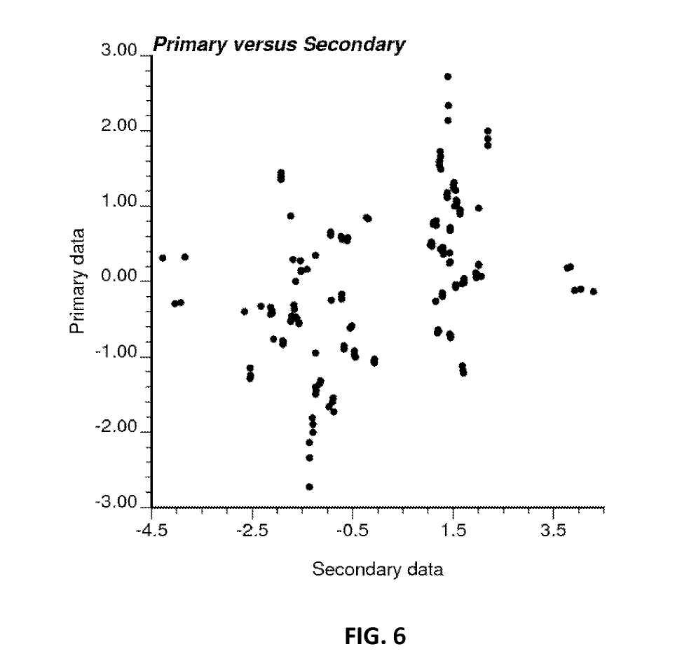

The likelihood modeling using Gaussian mixture begins with cross-plot of the collocated primary and secondary data as shown in FIG. 6.

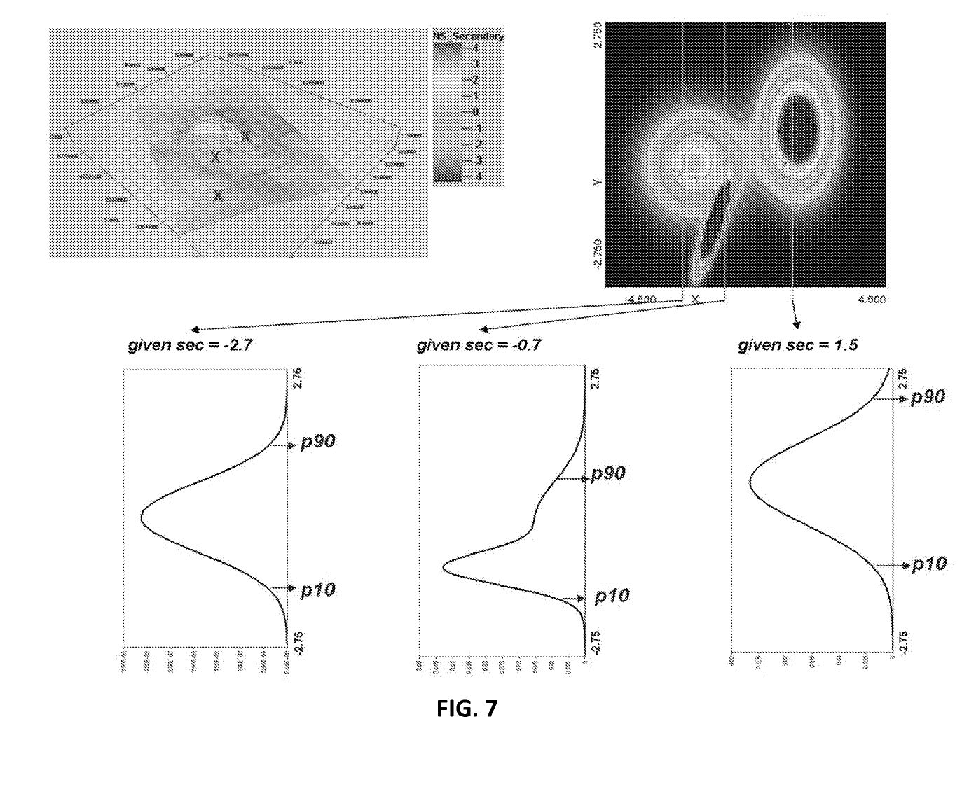

Expectation-Maximization (EM) algorithm finds a set of Gaussian pdfs to best account for the non-Gaussian relation between the primary and secondary data. In this example, EM algorithm found three bivariate Gaussian pdfs that best account for the bivariate data relation. Optimized mean vector, covariances and weights assigned to each Gaussian pdf are following:

$$f ( z ( u ) , y ( u ) ) = {w}_{1} {g}_{1} ( {μ}_{1} , {Σ}_{1} ) + {w}_{2} {g}_{2} ( {μ}_{2} , {Σ}_{2} ) + {w}_{3} {g}_{3} ( {μ}_{3} , {Σ}_{3} ) , \\ u ∈ A \\ \{ \begin{matrix}{w}_{1} = 0.37 \\ {μ}_{1} = ( - 1.56 , - 0.18 ) \\ {Σ}_{1} = ( \begin{matrix}0.72 & 0.02 \\ 0.02 & 0.49\end{matrix} )\end{matrix} \\ \{ \begin{matrix}{w}_{2} = 0.5 \\ {μ}_{2} = ( 1.63 , 0.51 ) \\ {Σ}_{2} = ( \begin{matrix}0.49 & 0.001 \\ 0.001 & 0.68\end{matrix} )\end{matrix} \\ \{ \begin{matrix}{w}_{3} = 0.13 \\ {μ}_{3} = ( - 0.99 , - 1.49 ) \\ {Σ}_{3} = ( \begin{matrix}0.1 & 0.15 \\ 0.15 & 0.32\end{matrix} )\end{matrix} \qquad ( 19 )$$

where Z and Y are the primary and secondary variable, respectively. The likelihood ƒ(z(u)|y(u)) is a conditional pdf at any given secondary data value y at location u. For example, in FIG. 7 three secondary data values collected from three different locations are input to the bivariate model and three likelihoods are extracted from the bivariate model using the given secondary data values. Selected locations are marked as X in 3D image and extracted likelihoods are shown at the bottom of FIG. 7. Because the likelihood is modeled in a non-parametric way, three likelihoods are different in shape, mean, variance. For example, the likelihood is more asymmetric shape when secondary data is −0.7 while conventional Bayesian updating generates the same likelihood pdf regardless of the given secondary data value. As described earlier, the likelihood pdfs can be characterized by a few parameters although the distributions are non-parametrically modeled.

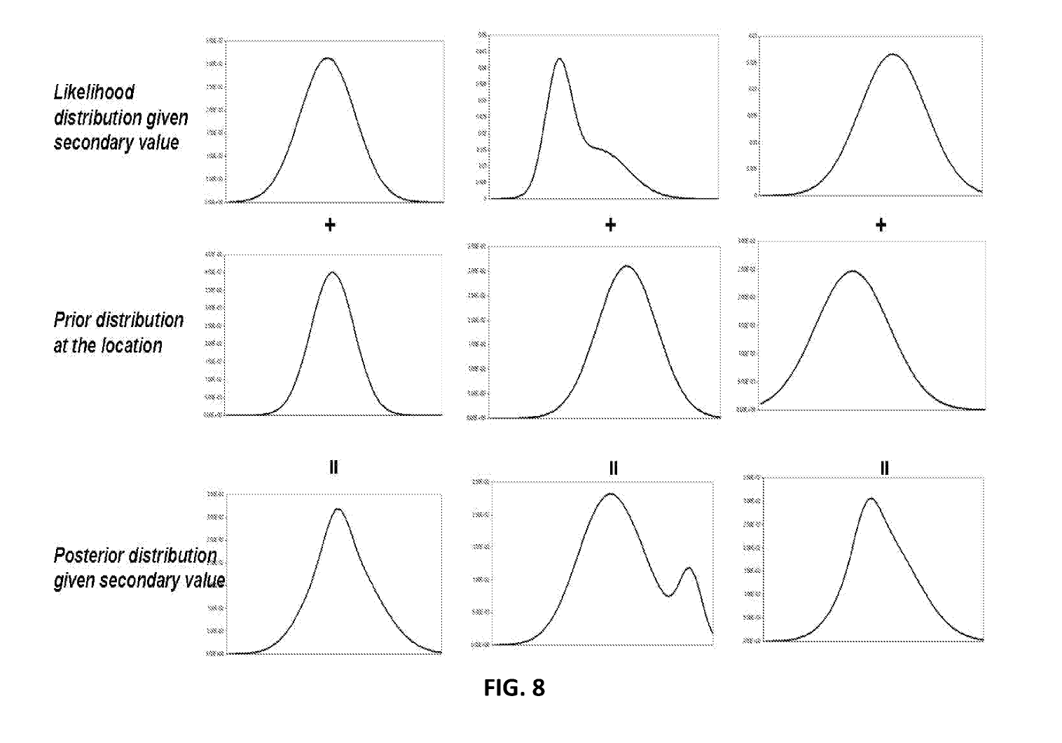

Once the bivariate probability distribution function ƒ(z,y) is modeled then the likelihood, ƒ(z|y) can be immediately derived at any given secondary data. The derived likelihood is then combined with a prior modeled by simple Kriging. FIG. 8 shows the updated pdfs (posterior pdfs) by combining the likelihoods and priors at three different locations used in FIG. 7.

The posterior pdf as shown in FIG. 8 is built over whole modeling location u, uεA. Once the local posterior pdf is built, any statistics such as mean, variance and p10/p90 of the primary variable can be calculated using the local posterior pdf. Locally built posterior pdf is fundamental to stochastic reservoir modeling algorithm such as sequential Gaussian simulation (SGS).

In closing, it should be noted that the discussion of any reference is not an admission that it is prior art to the present invention, especially any reference that may have a publication date after the priority date of this application. At the same time, each and every claim below is hereby incorporated into this detailed description or specification as additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

C. V. Deutsch and S. D. Zanon, 2004, Direct prediction of reservoir performance with Bayesian updating under a multivariate Gaussian model, Paper presented at the Petroleum Society's 5^{th} Canadian International Petroleum Conference, Calgary, Alberta, 8p.
P. M. Doyen, L. D. den Boer and W. R. Pillet, 1996, Seismic porosity mapping in the Ekofisk field using a new form of collocated cokriging. SPE 36498.
P. M. Doyen, 2007, Seismic Reservoir Characterization An Earth Modeling Perspective, EAGE Publications, Houten, Netherlands, 255p.
A. G. Journel and Ch. J. Huijbregts, 1981, Mining Geostatistics, Academic Press, London.
D. W. Scott, 1992, Multivariate Density Estimation: Theory, Practice, and Visualization. John Wiley and Sons, Inc., New York.
G. Verly, 1983, The Multigaussian approach and its applications to the estimation of local reserves, Mathematical Geology, Vol. 15, No. 2.
Christopher Bishop (2006) Pattern recognition and machine learning, New York, Springer
N. E. Day (1969) Estimating the components of a mixture of normal distributions Biometrika 56(3) 463-474.

1. A computer-implemented method for geostatistical reservoir modeling, the method comprising:
a) obtaining a prior probability distribution function using primary data;
b) obtaining a likelihood probability distribution function, via a computer processor, using secondary data, wherein the likelihood probability distribution function is obtained using a Gaussian mixture model that models non-linear relationship between the primary data and secondary data;
c) combining the prior probability distribution function with the likelihood probability distribution function to generate a posterior probability distribution function; and
d) outputting a reservoir model based on the posterior probability distribution function.

2. The method of claim 1, wherein the primary data directly measures a physical property of the reservoir.

3. The method of claim 1, wherein the secondary data indirectly measures a property of the reservoir.

4. The method of claim 1, wherein an Expectation-Maximum algorithm finds a set of Gaussian probability distribution functions to account for non-Gaussian relation between the primary data and secondary data.

5. The method of claim 1, wherein the posterior probability distribution function calculates a statistic selected from the group consisting of: mean, variance, p10, p90, and any combination thereof.

6. The method of claim 1, wherein the prior probability distribution function and the likelihood probability distribution function are combined by Kriging.

7. The method of claim 1, wherein the primary data is selected from the group consisting of: porosity, permeability, rock type, bitumen, organic carbon content and any combination thereof.

8. The method of claim 1, wherein the secondary data is selected from the group consisting of: inversed multiple seismic attributes, geologic map, geomechanical property, reservoir property previously modeled and any combination thereof.

9. A computer-implemented method for geostatistical reservoir modeling, the method comprising:
a) obtaining a prior probability distribution function using primary data that directly measures a physical property of the reservoir;
b) obtaining a likelihood probability distribution function, via a computer processor, using secondary data, wherein the likelihood probability distribution function is obtained using a Gaussian mixture model that models non-linear relationship between the primary data and secondary data;
c) combining the prior probability distribution function with the likelihood probability distribution function to generate a posterior probability distribution function; and
d) outputting a reservoir model based on the posterior probability distribution function.

10. The method of claim 9, wherein the secondary data indirectly measures a property of the reservoir.

11. The method of claim 9, wherein an Expectation-Maximum algorithm finds a set of Gaussian probability distribution functions to account for non-Gaussian relation between the primary data and secondary data.

12. The method of claim 9, wherein the posterior probability distribution function calculates a statistic selected from the group consisting of: mean, variance, p10, p90, and any combination thereof.

13. The method of claim 9, wherein the prior probability distribution function and the likelihood probability distribution function are combined by Kriging.

14. The method of claim 9, wherein the primary data is selected from the group consisting of: porosity, permeability, rock type, bitumen, organic carbon content and any combination thereof.

15. The method of claim 9, wherein the secondary data is selected from the group consisting of: inversed multiple seismic attributes, geologic map, geomechanical property, reservoir property previously modeled and any combination thereof.

16. A computer-implemented method for geostatistical reservoir modeling, the method comprising:
a) obtaining a prior probability distribution function using primary data that directly measures a physical property of the reservoir;
b) obtaining a likelihood probability distribution function, via a computer processor, using secondary data that indirectly measures a property of the reservoir, wherein the likelihood probability distribution function is obtained using a Gaussian mixture model that models non-linear relationship between the primary data and secondary data;
c) combining the prior probability distribution function with the likelihood probability distribution function to generate a posterior probability distribution function; and
d) outputting a reservoir model based on the posterior probability distribution function.

17. The method of claim 16, wherein an Expectation-Maximum algorithm finds a set of Gaussian probability distribution functions to account for non-Gaussian relation between the primary data and secondary data.

18. The method of claim 16, wherein the posterior probability distribution function calculates a statistic selected from the group consisting of: mean, variance, p10, p90, and any combination thereof.

19. The method of claim 16, wherein the primary data is selected from the group consisting of: porosity, permeability, rock type, bitumen, organic carbon content and any combination thereof.

20. The method of claim 16, wherein the secondary data is selected from the group consisting of: inversed multiple seismic attributes, geologic map, geomechanical property, reservoir property previously modeled and any combination thereof.
